(19) United States
(12) Patent Application Publication
(10) Pub. No.: US 2021/0358042 A1
(43) Pub. Date: Nov. 18, 2021

(54) STOCK RECOMMENDATION METHOD BASED ON ITEM ATTRIBUTE IDENTIFICATION AND THE SYSTEM THEREOF

(71) Applicant: HUNAN FUMI INFORMATION TECHNOLOGY CO., LTD., Changsha (CN)

(72) Inventors: Anquan WANG, Changsha (CN); Xiong LIU, Changsha (CN)

(21) Appl. No.: 17/143,673

(22) Filed: Jan. 7, 2021

(30) Foreign Application Priority Data
May 13, 2020 (CN) 20201040159.X

(51) Int. Cl. G06Q 40/06; G06F 16/2455; G06N 20/00; G06F 16/951; G06K 9/46; G06K 9/00; G06K 9/62

(52) U.S. Cl. CPC G06Q 40/06; G06F 16/2455; G06N 20/00; G06K 2209/01; G06K 9/46; G06K 9/00456; G06K 9/6217; G06F 16/951

(57) ABSTRACT

The disclosure provides a stock recommendation method based on item attribute identification and the system thereof. The method includes: receiving images to be identified and obtained by scanning items; conducting classified identification and text extraction on the images to be identified, and outputting classified identification information and text extraction information; searching on a search engine by using the classified identification information and the text extraction information as search conditions respectively, and outputting corresponding stock object information; and screening out stock object information matched with user preferences from the stock object information and recommending the screened-out stock object information to a user. By embodiments of the present invention, it can match with different attributes of the items in the images scanned by the user for discovering the meaning behind the items, then, discover the stocks related to the items, and recommend the stocks that the user likes most according to user preferences.

### CROSS-REFERENCE TO RELATED APPLICATIONS

The present application claims priority of Chinese patent application No. CN 202010401159.X filed on May 13, 2020, entitled “a stock recommendation method based on item attribute identification and the system thereof”.

### TECHNICAL FIELD

The disclosure relates to the technical field of stock recommendation, in particular, to a stock recommendation method based on item attribute identification and the system thereof.

### BACKGROUND

When finding themselves enjoying a great customer experience with an item, users often show an intention of investing in the item. For this reason, the users will be triggered to search for companies and industries related to the item through search engines or other media tools. However, such information may not be enough for the users to obtain the stock and fund information of the item which requires more searches by the users.

In the prior art, there are mainly two searching ways for stocks related to items:

1. Search with General Search Engine

Users search on a general search engine by using the name of the item and keywords associated with the item, such as xxx industry and xxx company and so on, obtain the names of relevant industries or companies according to search results, and then continue to use the above search engines to search based on the obtained list of industries or companies till the associated stocks are found, therefore, investment opportunities are found.

2. Search with Stock Software

Users conduct a search with the item as a keyword, for example, using “Apple” as a keyword to search for Apple Inc. An object that the users possibly want to search may be searched out when some stock trading software turns on a keyword association function; and in case of a stock search failure, it may need to search for the possible objects with tools similar to news search tools, but many kinds of stock trading software do not provide this function.

In current search methods, no matter one uses a general search engine, a special document retrieval tool or a search function of stock trading software, it is hard to get a good investment opportunity associated with the item. In many cases, complex retrieval operations are needed to get the desired results. In some other cases, it is impossible to obtain results. For example, many kinds of stock trading software do not provide a fuzzy search function, which indicates that it is unrealistic to purely use stock trading software to obtain tradable objects according to items. Moreover, because the general search engines do not know the context of the stock market well, the searched results according to the search engines will be only companies and entities related to the keywords, thereby limiting the scope of possibly obtained objects.

### SUMMARY

Purpose of the Disclosure

In order to overcome the shortcomings in the background art, the embodiments of the disclosure provide a stock recommendation method based on item attribute identification and the system thereof, which can effectively solve the problems involved in the prior art as described above.

### Technical Solution

A stock recommendation method based on item attribute identification includes:

Receiving images to be identified and obtained by scanning items;

Conducting classified identification and text extraction on the images to be identified, and outputting classified identification information and text extraction information respectively, wherein the classified identification information includes enterprise identification information corresponding to the intrinsic attributes of the items, enterprise identification information corresponding to the extended attributes of the items and enterprise identification information corresponding to the internal attributes of the items, and the text extraction information includes enterprise information corresponding to texts;

Searching on a search engine by using the classified identification information and the text extraction information as search conditions respectively, and outputting corresponding stock object information, wherein the search engine consists of a stock market data system, a market data import module, a distributed crawler and an ElasticSearch full-text search engine; and

Screening out stock object information matched with user preferences from the stock object information, and recommending the screened-out stock object information to a user.

As a preferred mode of the disclosure, the step of conducting classified identification and text extraction on the images to be identified and outputting classified identification information and text extraction information includes:

Inputting the images to be identified into an image classified identification system for identification, and outputting classified identification information, wherein the image classified identification system trains a pre-trained MobileNet classified identification model with Tensorflow, conducts distributed training on the pre-trained MobileNet classified identification model with Horovod, and is deployed on a Kubenetes platform through Kubeflow; and

Inputting the images to be identified into an image OCR text extraction system for text extraction, and outputting text extraction information, wherein the image OCR text extraction system uses an LSTM neural network for text identification of the images to be identified and is deployed on the Kubenetes platform through Kubeflow.

As a preferred mode of the disclosure, the step of searching on a search engine by using the classified identification information and the text extraction information as search conditions respectively and outputting corresponding stock object information includes:

Searching on the ElasticSearch full-text search engine by using the classified identification information and the text extraction information as search conditions respectively and outputting corresponding stock object information; and

Before searching on a search engine by using the classified identification information and the text extraction information as search conditions respectively and outputting corresponding stock object information, the method further includes:

Importing, by the market data import module, unstructured data in the stock market data system into the ElasticSearch full-text search engine by Flume, and importing structured data in the stock market data system into the ElasticSearch full-text search engine by Sqoop; and

Crawling, by the distributed crawler, stock information from the Internet and importing the stock information into the ElasticSearch full-text search engine.

As a preferred mode of the disclosure, before screening out stock object information matched with user preferences from the stock object information and recommending the screened-out stock object information to a user, the method further includes:

Collecting a user behavior log and importing the user behavior log into a Hadoop big data platform; and

Analyzing and training the user behavior log by using a Mahout collaborative filtering recommendation algorithm or a DeepFM algorithm and saving training results in a database.

As a preferred mode of the disclosure, the step of screening out stock object information matched with user preferences from the stock object information and recommending the screened-out stock object information to a user includes:

Matching the stock object information with the training results in the database to screen out stock object information matched with user preferences and recommending the screened-out stock object information to a user.

A stock recommendation system based on item attribute identification includes:

A to-be-identified image receiving module for receiving images to be identified and obtained by scanning items;

A classified identification module for conducting classified identification on the images to be identified and outputting classified identification information, wherein the classified identification information includes enterprise identification information corresponding to the intrinsic attributes of the items, enterprise identification information corresponding to the extended attributes of the items and enterprise identification information corresponding to the internal attributes of the items;

A text extraction module for conducting text extraction on the images to be identified and outputting text extraction information, wherein the text extraction information includes enterprise information corresponding to texts;

An object searching module for searching on a search engine by using the classified identification information and the text extraction information as search conditions respectively and outputting corresponding stock object information, wherein the search engine consists of a stock market data system, a market data import module, a distributed crawler and an ElasticSearch full-text search engine; and

An object recommendation module for screening out stock object information matched with user preferences from the stock object information and recommending the screened-out stock object information to a user.

As a preferred mode of the disclosure, the classified identification module is further used for inputting the images to be identified into an image classified identification system for identification and outputting classified identification information, wherein, the image classified identification system trains a pre-trained MobileNet classified identification model with Tensorflow, conducts distributed training on the pre-trained MobileNet classified identification model with Horovod, and is deployed on a Kubenetes platform through Kubeflow;

The text extraction module is further used for inputting the images to be identified into an image OCR text extraction system for text extraction and outputting text extraction information, wherein the image OCR text extraction system uses an LSTM neural network to conduct text identification of the images to be identified, and is deployed on the Kubenetes platform by Kubeflow.

As a preferred mode of the disclosure, the object searching module is further used for searching on the ElasticSearch full-text search engine by using the classified identification information and the text extraction information as search conditions respectively and outputting corresponding stock object information;

Wherein the market data import module is used for importing unstructured data in the stock market data system into the ElasticSearch full-text search engine by Flume, and importing structured data in the stock market data system into the ElasticSearch full-text search engine by Sqoop; and

The distributed crawler is used for crawling stock information from the Internet and importing the stock information into the ElasticSearch full-text search engine.

As a preferred mode of the disclosure, the system further includes:

A data collection module for collecting a user behavior log and importing the user behavior log into a Hadoop big data platform; and

A data training module for analyzing and training the user behavior log by using a Mahout collaborative filtering recommendation algorithm or a DeepFM algorithm and saving training results in a database.

As a preferred mode of the disclosure, the object recommendation module is further used for matching the stock object information with the training results in the database to screen out stock object information matched with the user preferences and recommending the screened-out stock object information to a user.

The disclosure may achieve the beneficial effects as below:

1. The disclosure may match different attributes of the items in the images scanned by a user so as to discover the meaning behind the items, then discover the stocks related to the items, and recommend the stock that the user likes most to the user according to user preferences.

2. By training the pre-trained MobileNet classified identification model with Tensorflow and conducting distributed training on the pre-trained MobileNet classified identification model with Horovod, the disclosure ensures the identification accuracy, meanwhile, ensures the operation efficiency.

3. By deploying the image classified identification system on the Kubenetes platform by Kubeflow, and scheduling CPU/GPU resources in a unified mode by Kubenetes, the disclosure effectively improves the resource utilization and development efficiency, and greatly reduces operation and maintenance costs. With Kubeflow, machine learning can be deployed in a portable and scalable manner.

4. By conducting offline calculation with the Mahout collaborative filtering algorithm and the DeepFM algorithm based on deep learning, the disclosure can map and classify user behaviors, so that the stock object information matching to the user preferences can be obtained.

### BRIEF DESCRIPTION OF FIGURES

The accompanying drawings herein, which are incorporated in and constitute a part of the specification, illustrate embodiments that are consistent with the disclosure and together with the specification, serve to explain the principles of the disclosure.

FIG. 1 is a flow diagram of a stock recommendation method based on item attribute identification provided by one embodiment of the disclosure;

FIG. 2 is an architecture diagram of an image classified identification system provided by one embodiment of the disclosure;

FIG. 3 is an architecture diagram of an image ORC text extraction system provided by one embodiment of the disclosure;

FIG. 4 is an architecture diagram of a search engine provided by one embodiment of the disclosure; and

FIG. 5 is an architecture diagram of a stock recommendation system based on item attribute identification provided by one embodiment of the disclosure.

### DETAILED DESCRIPTION

Hereinafter, the technical solution in the embodiments of the disclosure will be described clearly and completely with reference to the drawings in the embodiments of the disclosure. Obviously, the described embodiments are only part of the embodiments of the disclosure, not all of the embodiments.

### Embodiment 1

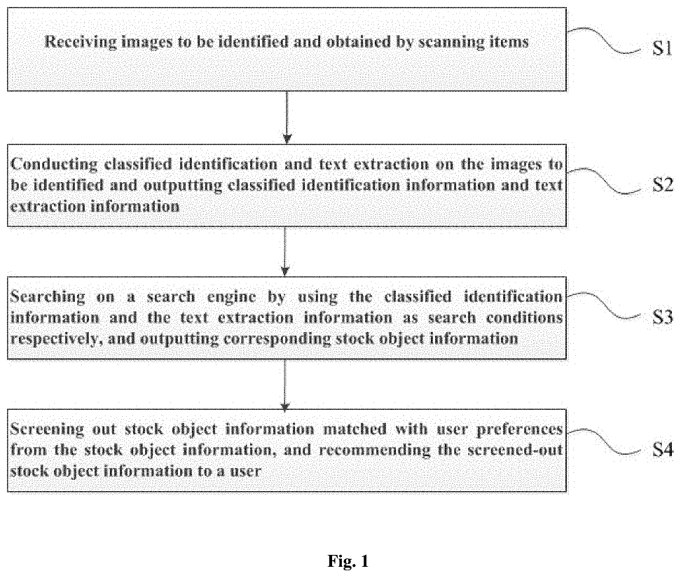

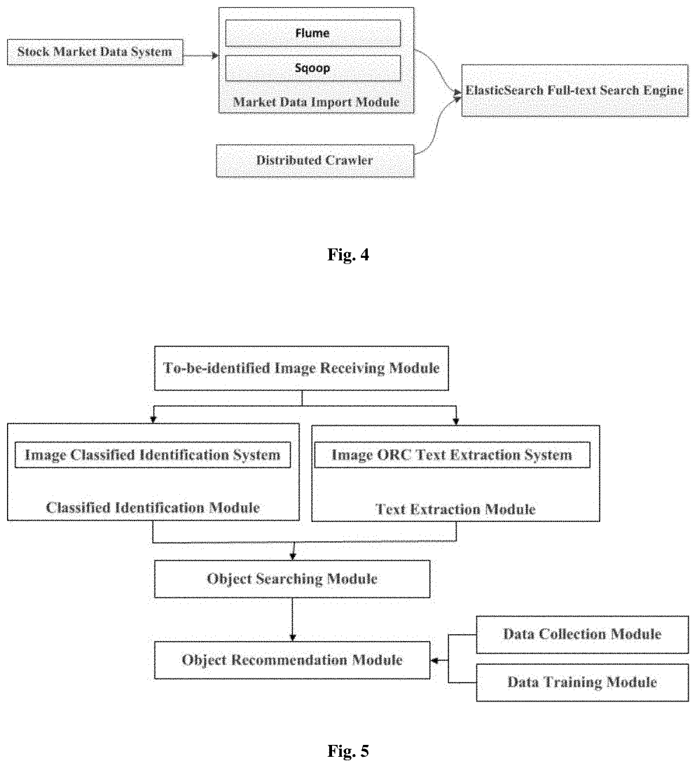

Referring to FIGS. 1-4, the present embodiment provides a stock recommendation method based on item attribute identification, which may be implemented by software and/or hardware installed or arranged in equipment, the software may be an application program, such as a typical APP, and the equipment may be a typical computer or mobile terminal and the like. The method includes the following steps:

S1, receiving images to be identified and obtained by scanning items.

In the present embodiment, the images to be identified may be images obtained by scanning the items by a user. For example, the user may turn on a camera to scan the items using the “Scan” function in the APP to obtain images having the items; receive the scanned images after scanning successfully, and use the scanned images as the images to be identified.

The items described in the present embodiment refer to objects having solid structures and existing in real life, and can also refer to virtual objects displayed in electronic equipment. The present embodiment mainly refers to the former, but it does not mean that the latter is not applicable to the present invention.

S2, conducting classified identification and text extraction on the images to be identified and outputting classified identification information and text extraction information, wherein the classified identification information includes enterprise identification information corresponding to the intrinsic attributes of the items, enterprise identification information corresponding to the extended attributes of the items and enterprise identification information corresponding to the internal attributes of the items, and the text extraction information includes enterprise information corresponding to texts.

In the present embodiment, after the images to be identified are received, classified identification and text extraction are conducted on the images to be identified. Specifically, the images to be identified are input into an image classified identification system for classified identification, and the images to be identified are input into an image OCR text extraction system for text extraction, and identified texts are extracted; and classified identification information is output after classified identification, and text extraction information is output after text identification. Image classified identification and text extraction are carried out at the same time. If there is no text in the images to be identified, the image OCR text extraction system will not output text extraction information.

The image classified identification system trains a pre-trained MobileNet classified identification model with Tensorflow, conducts distributed training on the pre-trained MobileNet classified identification model with Horovod, and is deployed on a Kubenetes platform through Kubeflow.

Tensorflow is a symbolic mathematics system based on dataflow programming, which is applied to the programming implementation of various machine learning algorithms. Tensorflow has a multi-level structure, can be deployed in various servers, PC terminals and web pages, and supports high-performance numerical calculation of GPU and TPU. MobileNet is a convolutional neural network, which has high speed and accuracy, and can keep the network and parameters small without losing identification accuracy too much. Horovod is a deep learning tool, which can help users realize distributed training. Kubeflow is a machine learning toolkit, which is a set of technology stack running on K8S. Kubeflow contains many components, which can be used together or used alone. TensorFlow serves as a first supported framework, and a new resource type is defined on the Kubernetes platform: TFJob, which is the abbreviation of TensorFlowJob. Through such a resource type, engineers who use TensorFlow for machine learning training no longer need to write complicated configurations, and only need to determine the numbers of PSs and workers and the input/output of data and logs according to their understanding of business to complete a training task. Kubeflow is a combinable, portable and scalable machine learning technology stack built for Kubernetes.

Through unified scheduling of CPU/GPU resources by means of the Kubernetes platform, the system can enjoy the convenience and high efficiency of Kubernetes. The Kubernetes platform makes the deployment of containerized applications easy and efficient. Machine learning can be deployed in a portable and scalable way by Kubeflow.

Wherein, the image classified identification system can not only identify the intrinsic attributes of the items (referring to matching with the items in terms of homonym or synonymy), but also identify the extended attributes of the items (referring to matching with production companies associated with the items and the categories of the items) and the internal attributes of the items (referring to matching with items inside the items).

For example, if the item displayed in the images to be identified is “apple” (fruit), the image classified identification system identifies that the enterprise identification information corresponding to the intrinsic attributes of the item may be “Apple” (Apple Inc.), or any company whose name or business scope includes planting apples, making apple juice, making juice containing apple juice, making food containing apple juice, producing dried apples, planting fruits, selling fruits, disposing apple kernels and apple peel, extracting some special components from apple, and producing apple-shaped toys, apple-shaped dolls and apple-shaped decorations.

If the item displayed in the images to be identified is a “mobile phone” (electronic equipment), the image classified identification system identifies that the enterprise identification information corresponding to the extended attributes of the item may be a manufacturer related to “mobile phone”, such as Apple, Xiaomi, Samsung and Huawei (the above companies are referred to for short), or a mobile phone sales agent, or any company whose name or business scope includes production and sale of mobile phone parts, mobile phone shells, mobile phone accessories, and mobile phone peripheral products.

If the item displayed in the images to be identified is an “automobile” (vehicle), the image classified identification system identifies that the enterprise identification information corresponding to the internal attributes of the item may be manufacturers related to internal parts (such as engine, motor and battery) of automobiles, such as BMW, Honda and CATL (the above companies are referred to for short), or an automobile sales agent, or any company whose name or business scope includes the production and sale of automobile parts, automotive paint, automobile films, automobile models, automobile decorations and automobile peripheral products.

Wherein, the image OCR text extraction system uses an LSTM neural network for text identification of the pictures to be identified and is deployed on the Kubenetes platform through Kubeflow.

LSTM (Long Short-Term Memory) neural network is a time cycle neural network, which is specially designed to solve the long-term dependence problem of general RNNs (recurrent neural network). All RNNs have a chain form of repeating neural network modules.

The image OCR text extraction system uses the LSTM neural network to identify the texts in the images to be identified, specifically, to identify the texts displayed in the images to be identified to obtain enterprise information corresponding to the texts.

For example, if the texts displayed in the images to be identified include “apple”, the image OCR text extraction system identifies that the enterprise information corresponding to the texts may be “Apple” (Apple Inc.).

S3, searching on a search engine by using the classified identification information and the text extraction information as search conditions respectively and outputting corresponding stock object information, wherein the search engine consists of a stock market data system, a market data import module, a distributed crawler and an ElasticSearch full-text search engine.

In the present embodiment, before operating S3, the method further includes:

importing, by the market data import module, unstructured data in the stock market data system into the ElasticSearch full-text search engine by Flume, and importing structured data in the stock market data system into the ElasticSearch full-text search engine by Sqoop; and crawling, by the distributed crawler, stock information from the Internet (such as financial websites and social networking sites) and importing the stock information into the ElasticSearch full-text search engine.

Flume (Log Collection System) provides the ability (customizable) to simply process data and write the data to various data recipients. Flume provides the ability to support TCP and UDP from console, RPC (Thrift-RPC), text (file), tail (UNIXtail) and syslog (syslog system), and collect data from data sources such as exec (command execution). Sqoop is an open source tool, which is mainly used to transfer data between Hadoop (Hive) and traditional databases (mysql, postgresql, etc.). Sqoop can import data from a relational database (such as MySQL, Oracle and Postgres) into Hadoop HDFS, and also import data from HDFS into relational databases. Elasticsearch is a Lucene-based search server, which provides a distributed multi-user full-text search engine based on a RESTfulweb interface.

In the embodiment, the specific embodiments of S3 include: searching on the ElasticSearch full-text search engine by using the classified identification information and the text extraction information as search conditions respectively and outputting corresponding stock object information.

For example, when the classified identification information is “Apple”, the corresponding stock object information searched and output is the stock object information corresponding to “Apple Companies”. When the classified identification information is manufacturers related to “mobile phone”, the corresponding stock object information searched and output is the stock object information corresponding to manufacturers related to “mobile phone”, such as the stock object information corresponding to companies such as Apple, Xiaomi, Samsung, and Huawei.

S4, screening out stock object information matched with user preferences from the stock object information and recommending the screened-out stock object information to a user.

In the present embodiment, before operating S4, it also needs to operate the following steps:

Collecting a user behavior log and importing the user behavior log into a Hadoop big data platform; analyzing and training the user behavior log by using a Mahout collaborative filtering recommendation algorithm or a DeepFM algorithm, and saving training results in a database.

In the present embodiment, the specific embodiment of S4 include: matching the stock object information with the training results in the database to screen out stock object information matched with the user preferences and recommending the screened-out stock object information to a user.

Specifically, when a user visits a website or an APP page, a user behavior log collection script file and script code collect the user behavior log, and recombine the user behavior log into a user behavior log data packet of a specified specification, which is sent through a predetermined protocol (such as HTTP protocol), specifically, the user behavior log is sent and imported into the Hadoop big data platform, and then the user behavior log is analyzed and trained by using the Mahout collaborative filtering recommendation algorithm or the DeepFM algorithm, and the training results are saved in the database.

By conducting offline calculation with the Mahout collaborative filtering algorithm (discovering user preferences for goods or content through the historical behavior data of the user) and the DeepFM algorithm based on deep learning (training a recommendation model with the historical behavior data of the user to recommend content), user behaviors can be well mapped and classified, so that the stock object information matching with the user preferences can be obtained.

In practical application, the above two algorithms can be switched as needed to achieve different effects.

It should be noted that if a corresponding matching result cannot be obtained when the stock object information is matched with the training results in the database (that is, none of the stock object information is matched with the user preferences), the stock object information before matching will be recommended to the user.

### Embodiment 2

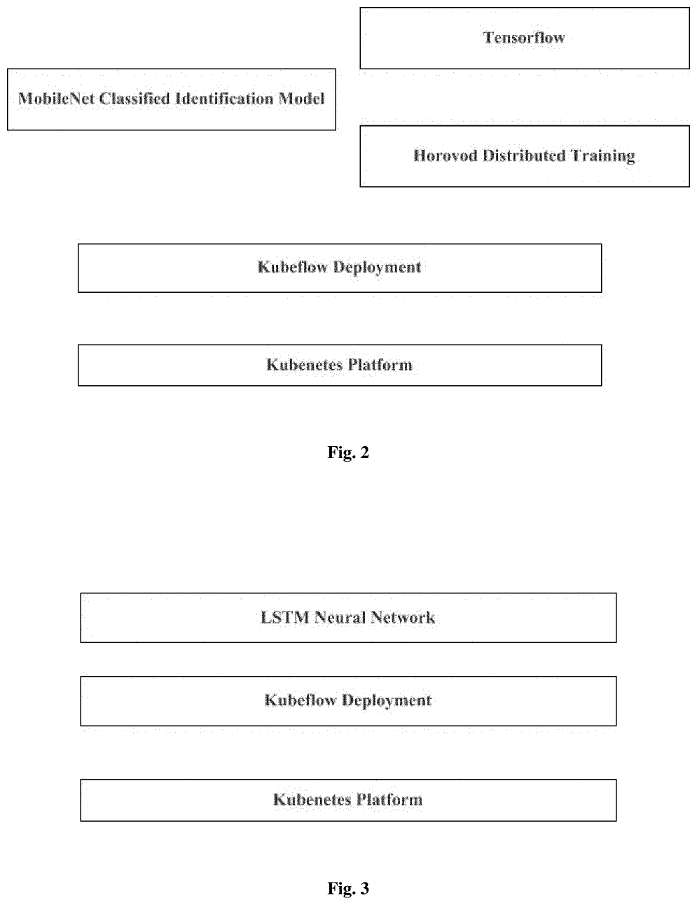

Referring to FIGS. 2-5, the embodiment provides a stock recommendation system based on item attribute identification, which including:

A to-be-identified image receiving module for receiving images to be identified and obtained by scanning items;

A classified identification module for conducting classified identification on the images to be identified and outputting classified identification information, wherein the classified identification information includes enterprise identification information corresponding to the intrinsic attributes of the items, enterprise identification information corresponding to the extended attributes of the items and enterprise identification information corresponding to the internal attributes of the items;

A text extraction module for conducting text extraction on the images to be identified and outputting text extraction information, wherein the text extraction information includes enterprise information corresponding to texts;

An object searching module for searching on a search engine by using the classified identification information and the text extraction information as search conditions respectively and outputting corresponding stock object information, wherein the search engine consists of a stock market data system, a market data import module, a distributed crawler and an ElasticSearch full-text search engine; and

An object recommendation module for screening out stock object information matched with user preferences from the stock object information and recommending the screened-out stock object information to a user.

As a preferred mode of the disclosure, the classified identification module is further used for inputting the images to be identified into an image classified identification system for identification and outputting classified identification information, wherein the image classified identification system trains a pre-trained MobileNet classified identification model with Tensorflow, conducts distributed training on the pre-trained MobileNet classified identification model with Horovod, and is deployed on a Kubenetes platform through Kubeflow; and

The text extraction module is further used for inputting the images to be identified into an image OCR text extraction system for text extraction and outputting text extraction information, wherein the image OCR text extraction system uses an LSTM neural network for text identification of the images to be identified, and is deployed on the Kubenetes platform through Kubeflow.

As a preferred mode of the disclosure, the object searching module is further used for searching in the ElasticSearch full-text search engine by using the classified identification information and the text extraction information as search conditions respectively and outputting corresponding stock object information;

Wherein the market data import module is used for importing unstructured data in the stock market data system into the ElasticSearch full-text search engine by Flume, and importing structured data in the stock market data system into the ElasticSearch full-text search engine by Sqoop; and

The distributed crawler is used for crawling stock information from the Internet and importing the stock information into the ElasticSearch full-text search engine.

As a preferred mode of the disclosure, the system further includes:

a data collection module, used for collecting a user behavior log and importing the user behavior log into a Hadoop big data platform; and

a data training module, used for analyzing and training the user behavior log by using a Mahout collaborative filtering recommendation algorithm or a DeepFM algorithm and saving training results in a database.

As a preferred mode of the disclosure, the object recommendation module is further used for matching the stock object information with the training results in the database to screen out the stock object information matched with the user preferences and recommending the screened-out stock object information to a user.

The specific implementation process of the present embodiment is consistent with Embodiment 1. Please refer to the above description for details.

The above embodiments are only for explaining the technical concept and characteristics of the disclosure, and the purpose is to enable those skilled in the art to understand the content of the disclosure and implement the disclosure accordingly, but not to limit the scope of protection of the disclosure. All equivalent transformations or modifications made according to the spirit of the disclosure should be covered within the scope of protection of the disclosure.

1. A stock recommendation method based on item attribute identification, wherein the method includes:
receiving images to be identified obtained by scanning items;
conducting classified identification and text extraction on the images to be identified and outputting classified identification information and text extraction information, wherein the classified identification information includes enterprise identification information corresponding to intrinsic attributes of the items, enterprise identification information corresponding to extended attributes of the items and enterprise identification information corresponding to internal attributes of the items, and the text extraction information includes enterprise information corresponding to texts;
searching on a search engine by using the classified identification information and the text extraction information as search conditions respectively and outputting corresponding stock object information, wherein the search engine consists of a stock market data system, a market data import module, a distributed crawler and an ElasticSearch full-text search engine; and
screening out stock object information matched with user preferences from the stock object information and recommending the screened-out stock object information to a user.

2. The stock recommendation method based on item attribute identification according to claim 1, wherein the step of conducting classified identification and text extraction on the images to be identified and outputting classified identification information and text extraction information includes:
inputting the images to be identified into an image classified identification system for identification and outputting the classified identification information, wherein, the image classified identification system trains a pre-trained MobileNet classified identification model by using Tensorflow, conducts distributed training on the pre-trained MobileNet classified identification model by using Horovod, and is deployed on a Kubenetes platform by Kubeflow; and
inputting the images to be identified into an image OCR text extraction system for text extraction and outputting the text extraction information, wherein the image OCR text extraction system uses an LSTM neural network for text identification of the images to be identified and is deployed on the Kubenetes platform by Kubeflow.

3. The stock recommendation method based on item attribute identification according to claim 1, wherein the step of searching on a search engine by using the classified identification information and the text extraction information as search conditions respectively and outputting corresponding stock object information includes:
searching in the ElasticSearch full-text search engine by using the classified identification information and the text extraction information as search conditions respectively and outputting corresponding stock object information;
before searching on a search engine by using the classified identification information and the text extraction information as search conditions respectively and outputting corresponding stock object information, the method further includes:
importing, by the market data import module, unstructured data in the stock market data system into the ElasticSearch full-text search engine by Flume, and importing structured data in the stock market data system into the ElasticSearch full-text search engine by Sqoop; and
crawling, by the distributed crawler, stock information from the Internet; and importing the stock information into the ElasticSearch full-text search engine.

4. The stock recommendation method based on item attribute identification according to claim 1, wherein, before screening out stock object information matched with user preferences from the stock object information and recommending the screened-out stock object information to a user, the method further includes:
collecting a user behavior log and importing the user behavior log into a Hadoop big data platform; and
analyzing and training the user behavior log by using a Mahout collaborative filtering recommendation algorithm or a DeepFM algorithm, and saving training results in a database.

5. The stock recommendation method based on item attribute identification according to claim 4, wherein the step of screening out stock object information matched with user preferences from the stock object information and recommending the screened-out stock object information to a user includes:
matching the stock object information with the training results in the database to screen out stock object information matched with the user preferences, and recommending the screened-out stock object information to a user.

6. A stock recommendation system based on item attribute identification, wherein the system includes:
a to-be-identified image receiving module for receiving images to be identified obtained by scanning items;
a classified identification module for conducting classified identification on the images to be identified and outputting classified identification information, wherein the classified identification information includes enterprise identification information corresponding to intrinsic attributes of the items, enterprise identification information corresponding to extended attributes of the items and enterprise identification information corresponding to internal attributes of the items;
a text extraction module for conducting text extraction on the images to be identified and outputting text extraction information, wherein the text extraction information includes enterprise information corresponding to texts;
an object searching module, used for searching on a search engine by using the classified identification information and the text extraction information as search conditions respectively and outputting corresponding stock object information, wherein the search engine consists of a stock market data system, a market data import module, a distributed crawler and an ElasticSearch full-text search engine; and
an object recommendation module for screening out stock object information matched with user preferences from the stock object information and recommending the screened-out stock object information to a user.

7. The stock recommendation system based on item attribute identification according to claim 6, wherein the classified identification module is further used for inputting the images to be identified into an image classified identification system for identification and outputting the classified identification information, wherein the image classified identification system trains a pre-trained MobileNet classified identification model with Tensorflow, conducts distributed training on the pre-trained MobileNet classified identification model with Horovod, and is deployed on a Kubenetes platform through Kubeflow; and
the text extraction module is further used for inputting the images to be identified into an image OCR text extraction system for text extraction and outputting the text extraction information, wherein the image OCR text extraction system uses an LSTM neural network for text identification of the images to be identified and is deployed on the Kubenetes platform through Kubeflow.

8. The stock recommendation system based on item attribute identification according to claim 6, wherein the object searching module is further used for searching in the ElasticSearch full-text search engine by using the classified identification information and the text extraction information as search conditions respectively and outputting corresponding stock object information;
wherein the market data import module is used for importing unstructured data in the stock market data system into the ElasticSearch full-text search engine through Flume, and importing structured data in the stock market data system into the ElasticSearch full-text search engine through Sqoop; and
the distributed crawler is used for crawling stock information from the Internet and importing the stock information into the ElasticSearch full-text search engine.

9. The stock recommendation system based on item attribute identification according to claim 6, wherein the system further includes:
a data collection module for collecting a user behavior log and importing the user behavior log into a Hadoop big data platform; and
a data training module for analyzing and training the user behavior log by using a Mahout collaborative filtering recommendation algorithm or a DeepFM algorithm and saving training results in a database.

10. The stock recommendation system based on item attribute identification according to claim 9, wherein the object recommendation module is further used for matching the stock object information with the training results in the database to screen out stock object information matched with the user preferences and recommending the screened-out stock object information to a user.
